(19) United States
(12) Patent Application Publication
(10) Pub. No.: US 2009/0283619 A1
(43) Pub. Date: Nov. 19, 2009

(54) Grip design for fishing reels

(76) Inventor: John N. Young, Fairfax, CA (US)

Correspondence Address: Pacific Products, 936B7th St #164, NOVATO, CA, 94945, US

(21) Appl. No.: 12/152,887

(22) Filed: May 19, 2008

(51) Int. Cl. A01K 89/00

(52) U.S. Cl. 242/283; 74/545; 43/4

(57) ABSTRACT

A fishing reel handle grip design formed to produce optimal gripping ability and comfort by considering the ergonomic requirements of a fisherman's natural gripping hand shape as well as his body and arm alignment while loosely and comfortably grasping said grip.

### CROSS-REFERENCE TO RELATED APPLICATIONS

The following references are considered relative prior art.

U.S. Pat. No. 5,328,128

D529,125

U.S. Pat. No. 5,660,344

### STATEMENT REGARDING FEDERALLY SPONSORED RESEARCH OR DEVELOPMENT

Not applicable

### REFERENCE TO SEQUENCE LISTING, TABLE, OR DISK APPENDIX

Not applicable

### BACKGROUND OF THE INVENTION

There are many designs used for the handles of fishing reels, but few address the optimal construction needed to properly fit the hand of a fisherman so as to permit maximum gripping strength and comfort during a fish fight.

### PURPOSE OF THE INVENTION

It is a purpose of this invention to teach a fishing reel handle assembly that ergonomically conforms to the angular position and form of a fisherman's hand.

### BRIEF DESCRIPTION OF THE DRAWINGS

FIG. 1 shows a top view of a hand and the cross section of an optimum grip shape for grasping with the fingers.

FIG. 2 shows the angular alignment to a perpendicular reference of a hand in a relaxed position as it holds a grip

FIG. 3 shows the silhouette of an optimum grip shape as it is grasped by a hand.

FIG. 4 shows a profile view of a handle assembly as it is aligned to a fishing reel while turning a driving member of the reel.

FIG. 5 is an angled view of the handle assembly of FIG. 4.

FIG. 6 is a side view of the grip of the invention.

FIG. 7 shows various cross sections of the grip of FIG. 6.

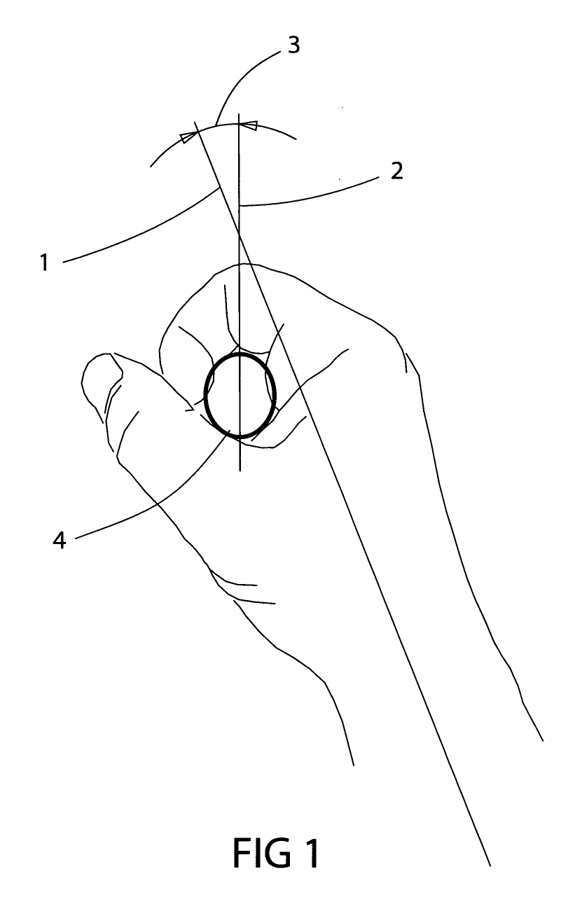

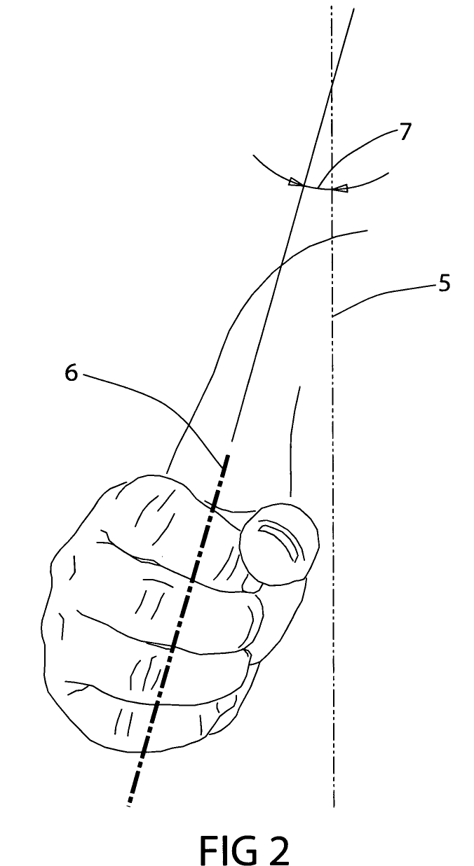

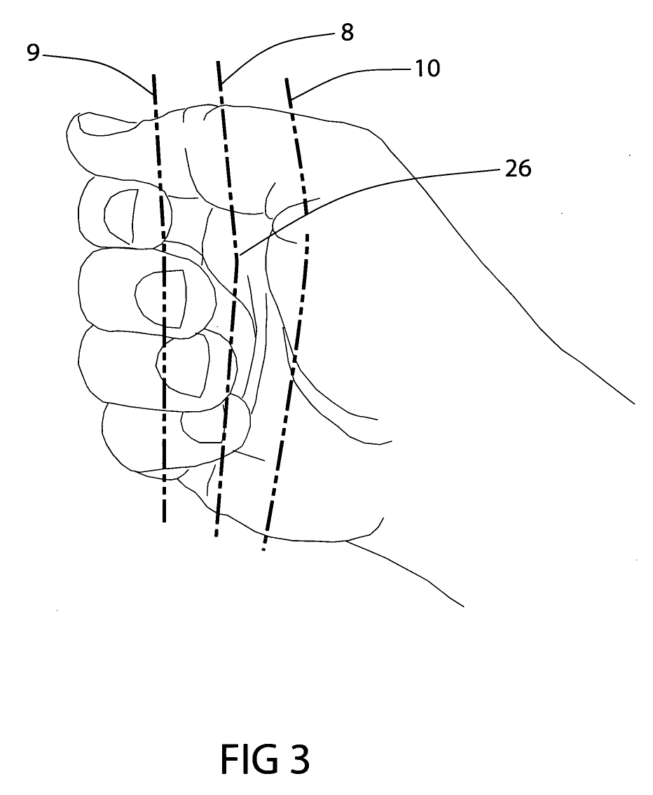

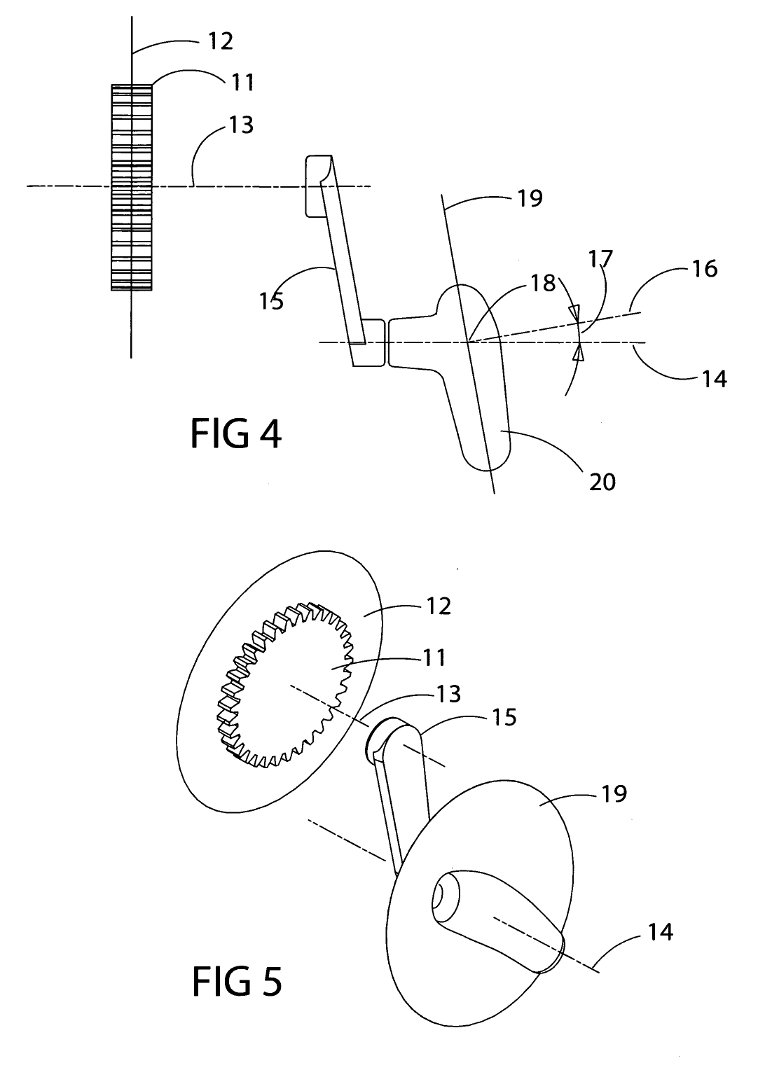

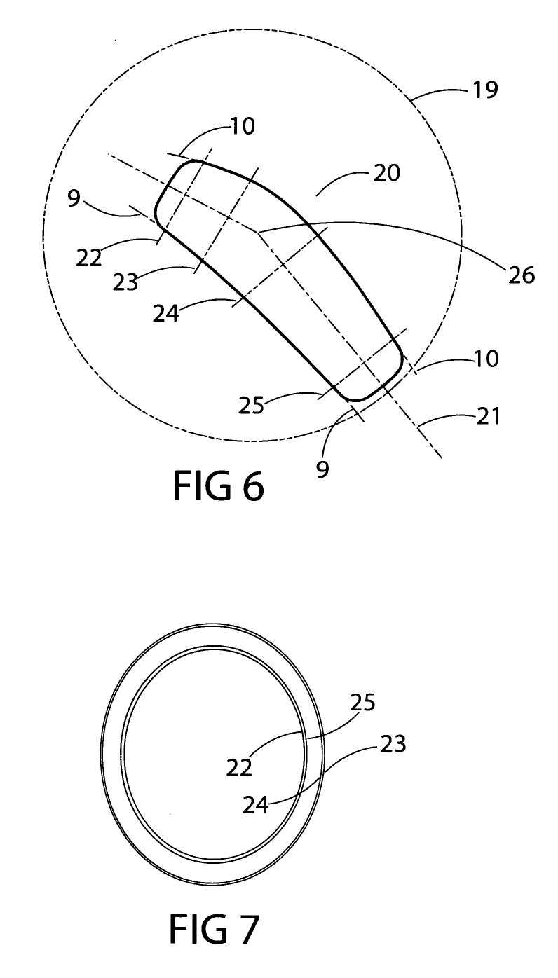

### DETAILED DESCRIPTION OF THE INVENTION

An optimal handle grip for a fishing reel may be defined as a grip that gives a fisherman maximum grip strength with minimal gripping exertion. To achieve this optimum handle grip design it is critical to design the grip with a cross sectional shape that matches the natural shape of the grip cavity created by a grasping hand. Equally important is to design the grip with minimum positional offsets from a fisherman's natural, relaxed arm and hand alignments while loosely and comfortably holding said grip. To this end, it is important to know that there are two major hand alignment considerations and three major grip profile considerations to consider when designing an optimal handle grip shape. These alignments and profiles are illustrated in the accompanying FIGs to which the following description refers.

The first of the two major hand alignments to consider is the angle 3 formed between the natural, resting axis 2 of the hand to the axis of the forearm 1 while comfortably holding a grip 4. The second of the major hand alignments to consider is the angle 7 formed between the vertical alignment 5 of a fisherman's body and the natural, resting axis 6 of the fisherman's hand as he comfortably holds a grip. For most people, angle 7 is typically about 20°.

The first of the two grip profile considerations is the cross sectional shape of the grip. It is an aspect of human anatomy that the loose grip of most healthy hands automatically forms an ovaloid cavity within the hand's grasp having an aspect ratio (short axis length to long axis length) of approximately 1:1.2. While this ovaloid aspect ratio remains constant along the full length of the grip cavity, the overall dimension of the ovaloid varies to produce a center-bulging profile with maximum bulge located near the base of the thumb.

The center bulging feature of the grip cavity is the second grip profile consideration. Within the grip cavity, the edge profile 9 pressing against the inside of the fingers is relatively straight, while the edge profile 10 shows that maximum distension of the bulge presses against the base of the thumb.

The third grip profile consideration is also a natural feature of most healthy hands and may be described as a bend in the grip cavity axis 8 which also occurs at the base of the thumb. This bend remains about 19° on the vast majority of hands—no matter the hand size, and almost all healthy hands may be included if the range is expanded to include any angle between 16° and 20°.

With an understanding of the desired ergonomic considerations of a gripping hand, an optimum handle grip design may be described in the following manner.

In a fishing reel, not shown, driving member 11 is held rotatably fixed to the reel so as to rotate in gear plane 12 upon axis 13. Grip axis 14 is held in rotatable alignment about axis 13 by conventional handle arm 15. At a distance from the handle arm along grip axis 14, point 18 marks the beginning of offset axis 16 so that the offset angle forms offset angle 17. Grip plane 19 aligns perpendicular to the offset angle at starting point 18 so that the grip plane 19 is at all times unaligned with gear plane 12.

The profiles to form the grip shape are laid out upon the grip plane. Since pushing pressure from a hand against a grip is usually greatest at the base of the thumb, it is desirable to position cavity axis bend 26 at the approximate intersection of the grip plane and the grip axis at starting point 18. Grip cavity surface profiles 9 and 10 determine the side profile limits of the grip shape, and at various points along the center bend-axis, perpendicular axis' 22, 23, 24, 25 set the position of any number of cross-sectional profiles that all have the same cross-sectional shape and proportions, but not the same dimensions as illustrated in FIG. 7.

A grip so constructed produces an optimum handle grip design that satisfies the requirements of all hand alignment and grip profile considerations described above. While an ovaloid grip cross section has been used throughout this description, it is understood by those with knowledge of the art that triangle, square and other alternate cross sectional shapes may be used to produce different feeling handle grips without changing the scope and nature of this patent.

1. A fishing handle reel grip rotatable on a grip axis and part of a handle assembly used to turn a driving element of a fishing reel, and shaped so as to allow maximum ergonomic conformity to the mechanics of a fisherman's hand as his hand produces a natural grasping cavity during a loose and comfortable grasp and includes:
A grip cross-section axis alignment to match the resting alignment between a fisherman's forearm and the cross-sectional axis of the grasping cavity;
A grip profile shape with a central axis having a bend to match the central axis bend formed in the grasping cavity;
A grip profile shape with curved profile extents to match the curved profile extents of the grasping cavity;
A grip profile plane alignment angle to match the angle formed between the axis of the grasping cavity and the vertical axis of a fisherman's upright body;
A varying grip cross section profile along the grip axis in which the various cross sectional profiles are different enlargements, of the same shape.

2. The grip of claim 1 in which the grip central axis bend is between 16° and 20°.

3. The grip of claim 1 in which the grip profile plane alignment angle is between 15° and 25°.

4. A fishing reel handle grip rotatable on a grip axis and whose profile shape is determined on a construction plane formed perpendicular to an offset axis that starts on the grip axis but extends other than along the grip axis and includes:
A grip profile shape with a central bent axis to match the central bent axis formed in the grasping cavity;
A grip profile shape with curved profile extents matching the curved profile extents of the grasping cavity;
A varying grip cross section profile along the bent grip axis in which the various cross sectional profiles are of different enlargements of the same shape.

5. The grip of claim 4 in which the angle formed between the offset axis and the grip axis is between 15° and 25°

6. A fishing reel handle grip rotatable on a grip axis and part of a handle assembly used to turn a driving element of a fishing reel and whose profile shape is formed on a construction plane that is not parallel to the rotating plane of the driving element and includes:
A grip profile shape with a central bent axis matching the central bent axis of the grasping cavity;
A grip profile shape with curved profile extents to match the curved profile extents of the grasping cavity;
A varying grip cross section profile along the bent grip axis in which the various cross sectional profiles are different enlargements of the same shape.

7. The grip of claim 6 in which the angle formed at the intersection of the construction plane and the rotating plane of the driving element is between 15° and 25°.

8. A fishing reel handle grip designed with multiple enlargements of a single cross section shape arranged along a non-linear axis, forming a bulged grip shape matching the bulged cavity shape of a grasping hand.
